(19) United States
(12) Patent Application Publication
(10) Pub. No.: US 2025/0141885 A1
(43) Pub. Date: May 1, 2025

(54) System, Method and Computer Program Product for Improved Browsing Security

(71) Applicant: Guardio Ltd., Tel-Aviv (IL)

(72) Inventors: Amir SEGER, Herzliya (IL); Natan TAL, Rosh HaAyin (IL); Oleg ZAYTSEV, Petah Tikva (IL)

(21) Appl. No.: 18/930,644

(22) Filed: Oct. 29, 2024

Related U.S. Application Data
(60) Provisional application No. 63/594,242, filed on Oct. 30, 2023.

(51) Int. Cl. H04L 9/40

(52) U.S. Cl. CPC H04L 63/14

(57) ABSTRACT

Method for enhancing a user's browsing security including providing solution code on a user's device; each time a user browses to a service/webapp made available to users by a webapp server, using the solution code for removing real cookie/s sent to the user's browser by the webapp server and stored by user U's browser in a cookie store in the user's device; storing the real cookie in storage accessible to the solution code but outside the cookie store; and subsequently, e.g. when the browser on the user's device sends a request which needs to include said real cookie, toward the service/webapp, accessing the real cookie from the storage outside the cookie store, modifying the request by adding the real cookie as accessed, and sending the request as modified on to the webapp server.

### BACKGROUND

A client, e.g., user device's browser, sends “requests” (e.g., http requests) to webapps' servers. Each such server sends “responses” (e.g., data and files that are needed to enable the webapp to load on the user device) back to the browser. A server may, having received an HTTP request, send Set-Cookie header/s to the browser. The browser may then store cookie/s and, subsequently, send the cookie/s, e.g., inside a Cookie HTTP header, with or in future requests made to that server.

Cookies typically comprise a name and a character string value and may be stored by the browser on a desktop or mobile device file system when a user visits a web app e.g., website. The web app server uses cookies to remember users' preferences and settings and/or to track users' browsing activity and/or to identify and authenticate users. Users can typically manage cookie settings in their browser settings which may enable users to disable cookies completely, or to choose to allow some types of cookies but not others on various webapp domains.

Many browser technologies are available. Some are open-sourced. Other browsers such as Safari and Firefox are not open-sourced. However, most browsers allow extension/add-ons, and provide APIs for 3^{rd} party developers.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY

Certain embodiments seek to improve session protection including providing better protection of mechanisms e.g. session cookies, which are used to authenticate and maintain connectivity to a service. Typically the improved session protect herein prevents these mechanisms from being copied and/or duplicated by malevolent software or actors which may seek to facilitate account and/or credentials theft.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to improve user security by preventing theft of cookies from browsers residing on devices of users engaged in browsing web apps.

According to certain embodiments, the system herein updates or modifies HTTP requests to include real value/s of session cookie/s, where the real values are stored other than in the browser's cookie store and/or are retrieved from a location other than the browser's cookie store. Typically, the system herein modifies HTTP request/s by intercepting and/or disabling and/or overriding and/or otherwise tampering with the browser's natural functionality which is to send a value from the cookie store, since, according to embodiments herein, the value in the cookie store is not the real value, e.g., will not, if sent to the webapp, result in the webapp server sending back responses which will enable the webapp to load properly on the user device and include secure content available to the authenticated user only.

Typically, the system focuses on cookies that store relevant session authentication information used by webapp servers to identify and authenticate the user, and which may be referred to as session cookies. A set of selectable session cookies (different per each webapp or service) is managed and secured by the solution. This may be done by replacing their value on the cookie store (of the browser) with generated (“fake”) value and saving the genuine (“real”) value that is used to authenticate the session in a secure memory controlled by the solution. The system may be implemented as solution code configured for monitoring the HTTP communication, and each time a state of genuine communication with the supported webapp/service is detected, as opposed to non-genuine communication with another entity entirely, the system controller code ensures the requests are updated to include the real values of the session cookies to maintain active and authenticate sessions. The system typically includes monitoring functionality which monitors responses to make sure the session is active, detects new session creation or token refresh activity, as well as session end states, and responds suitably, e.g., as described herein.

It is appreciated that the system typically distinguishes genuine from non-genuine communication to avoid leakage (exposure) of secret session tokens which would result were the solution code to mistakenly add a real cookie value to a request going to a non-supported or unauthorized site. The solution code therefore typically is configured to check every request going out and make sure it is genuine, e.g., by ascertaining that the destination service domain is recognized by the solution code as a supported and relevant web app, and that the request is made from the right context and/or origin, rather than, say, from a 3rd party website requesting resources from a supported webapp that doesn't require identification or authentication.

To distinguish genuine from non-genuine communication, the system herein may, for example store each cookie per a specific domain (e.g., for facebook.com) and may be configured not to add a cookie stored per domain x, to any domain other than x. Alternatively, or in addition, the system herein may for example ensure that a cookie's origin is from the website itself and not from any other site that may request resources from the service. Alternatively, or in addition, the system herein may for example check context-relevant requests from the domain, e.g., not to add a cookie value to a login page request, or to logout request etc. This may follow conventional practices, just as conventional browsers and webapps are configured to do.

Typically, the system monitors and controls specific webapps/services according to managed configuration, allowing adding more services and controlling service-specific behavior, such as but not limited to cookie names specific to a given web app, error codes specific to a given web app, specific resources requested from the webapp (e.g., logout or login pages) and session status activity whose characteristics differ for different web apps.

Typically, M real cookie values and M fake cookie values are stored for M users or M devices, each typically on-premise. Typically, fake value is more accessible to outside processes (e.g., malware/stealers) than is the real value. The fake value may be in the cookie store and may be encrypted, only if and to the extent that the Used Browser encrypts this cookie. For example, the extension may store the real value of the cookie for user m on the extension/browser memory of user m's device, typically in process memory, so as not to be accessible to other processes, so the data (real cookie value) is protected. For example, the real cookie value may be stored in a browser's extension sandboxed local memory, or the general browser processes memory. Once the browser is shutdown or the program process is exited, the real value is typically stored back on the file system, where no effective encryption may be provided by the browser internal storage. For example, a browser may encrypt cookies on a file system using a decryption key stored in a file right next to the cookies such that the encryption is rendered ineffective in practice, similarly to locking one's door with a physical key then leaving the key under the doormat.

Typically, while a fake cookie value may be stored in the browser's cookie store, the real value is stored on the solutions memory of user m's device, typically encrypted. The system may decrypt the cookie data aka real cookie value, e.g., as described herein. System servers may store the decryption key and may provide the decryption key to the user's browser only after authentication and/or in return for a PIN code.

Either way, the real value of the cookie is typically never stored at the server side thus typically, even if the system herein does have a server side, real cookie values are never stored there at any time.

Any suitable method may be employed by the solution herein to decrypt the real cookie value, e.g., as described elsewhere herein. A user may obtain a description key from external servers, to which the user has previously onboarded. Typically, onboarding of users to the external servers includes providing each user with an ID of her or his own and/or an ID for each of his/her devices; these IDs are known, other than to the external servers, only to the user. The external servers may create a unique encryption key per each relevant device of each user.

These servers thus typically store decryption key/s for all M users and typically provide these keys to the user's solution herein only after authentication of the user vis à vis the solution herein. For example, the user may be given access to his decryption key by providing the server with a PIN code or personal password previously assigned uniquely to, and only known by, the user.

The terms cookie “value”, “token”, and cookie “data” may be interchanged here within, and may refer to content of a specific cookie which may be identified by that cookie's unique name.

It is appreciated that any reference herein to, or recitation of, an operation being performed is, e.g., if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g., over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention thus typically includes at least the following embodiments:

Embodiment 1. A system for enhancing security for users engaged in browsing activity via respective browsers installed on users' respective devices, the system comprising an HTTP communication analyzer, e.g., hardware processor which analyzes HTTP responses incoming to a user's device from webapp/s servers and/or HTTP requests outgoing from the browser on a user's device to web apps servers, including identifying incoming cookie values (aka real values) being sent, e.g., in HTTP responses, from web app/s servers to the browser and outgoing cookie values being sent, e.g., in HTTP requests, from the browser toward web app/s servers; and/or a controller e.g. hardware processor which, responsive to at least one incoming cookie having been identified by the HTTP communication analyzer, stores the incoming cookie value typically in a location other than the user device's browser's cookie store, and/or deletes at least the incoming cookie value from the user device's browser's cookie store, thereby to store at least one real value only outside the cookie store. Typically, the controller at least once adds at least one real value outside the cookie store to at least one service message request which may be outgoing from the user device's browser toward at least one web app.

Embodiment 2. A system according to any of the preceding embodiments wherein the controller adds the at least one real value outside the cookie store to the at least one service message, responsive to a relevant service request having been identified by the HTTP communication monitor.

Embodiment 3. A system according to any of the preceding embodiments wherein the system also comprises a cookie generator and wherein the controller also stores an alternative value in the user device's cookie store.

Embodiment 4. A system according to any of the preceding embodiments wherein the alternative value comprises a fake cookie value, generated by the cookie generator, thereby to store at least one real value outside the cookie store corresponding to at least one fake value in the cookie store.

Embodiment 5. A system according to any of the preceding embodiments wherein the controller deletes the entire incoming cookie value from the user device's browser's cookie store.

Embodiment 6. A system according to any of the preceding embodiments wherein the location at which the incoming cookie value is stored, is on the user's device outside of the browser's cookie store.

Embodiment 7. A method for enhancing a user's browsing security, the method comprising using solution code on a user's device (e.g., in the device's browser program) at least once, e.g. each time a user browses to a service or webapp made available to users by a webapp server, for: removing at least one real cookie which was sent to the user's browser by the webapp server and has been stored by user U's browser in a cookie store in the user's device; and/or storing the real cookie in storage accessible to the solution code but outside the cookie store; and/or, typically subsequently, on at least one occasion when the browser on the user's device sends a request which needs to include the real cookie (e.g., a request which needs to include a session cookie), toward the service/webapp, accessing the real cookie from the storage outside the cookie store and/or modifying the request by adding the real cookie as accessed, and/or sending the request as modified on to the webapp server.

Embodiment 8. A method according to any of the preceding embodiments wherein a fake cookie is stored in the user device's browser program's cookie store, and wherein subsequently, the request is modified by replacing a cookie value within the request, which, having been retrieved by the browser program from the cookie store, is fake, with the real cookie value.

Embodiment 9. A method according to any of the preceding embodiments wherein the removing comprises:
replacing at least one real cookie which was sent to the user's browser by the webapp server and has been stored by user U's browser in a cookie store in the user's device, with a fake cookie value and/or removing the cookie from the cookie store; and/or storing a blank value in the cookie's value, instead of the real value that was removed.

Embodiment 10. A method according to any of the preceding embodiments wherein the method includes removing the fake cookie each time the session is revoked by the user or the service itself.

Embodiment 11. A system according to any of the preceding embodiments wherein the system is implemented in solution code and wherein the real value is stored in a secured location such as the solution code's sandboxed memory.

Embodiment 12. A system according to any of the preceding embodiments wherein the real value is stored encrypted on the user device's file system.

Embodiment 13. A system according to any of the preceding embodiments wherein the real values are stored in plain text, i.e., un-encrypted on process memory managed by the operating system of the user's device.

Embodiment 14. A system according to any of the preceding embodiments wherein at least one incoming cookie value, which needs to be stored on the user's device for persistence, is stored encrypted on the device's file system. Any suitable encrypting method may be used e.g. as described elsewhere herein.

Embodiment 15. A system according to any of the preceding embodiments wherein the controller adds the at least one real value outside the cookie store by replacing the outgoing cookie value, which, having been retrieved by the browser from the cookie store, is fake, with at least one real value outside the cookie store corresponding to the fake outgoing cookie value.

Embodiment 16. A system according to any of the preceding embodiments wherein the alternative value comprises a null string comprising zero characters.

Embodiment 17. A system according to any of the preceding embodiments wherein the location at which the incoming cookie value is stored, is in device memory.

Embodiment 18. A computer program product, comprising a non-transitory tangible computer readable medium having computer readable program code embodied therein, the computer readable program code adapted to be executed to implement a method for enhancing a user's browsing security, the method comprising: at least once e.g. each time a user browses to a service or webapp made available to users by a webapp server, using the solution code on a user's device for removing at least one real cookie which was sent to the user's browser by the webapp server and has been stored by user U's browser in a cookie store in the user's device and/or storing the real cookie in storage accessible to the solution code, but outside the cookie store; and subsequently, e.g. on at least one occasion when the browser on the user's device sends a request which needs to include the real cookie (e.g., a request which needs to include a session cookie), toward the service/webapp, accessing the real cookie from the storage outside the cookie store and/or modifying the request e.g. by adding the real cookie as accessed, and/or sending the request as modified on to the webapp server.

Also provided, excluding signals, is a computer program comprising computer program code means for performing any of the methods shown and described herein when the program is run on at least one computer; and a computer program product, comprising a typically non-transitory computer-usable or readable medium e.g., non-transitory computer-usable or readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or by a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g., USB)), a computer program stored in memory/computer storage.

The term “process” as used above is intended to include any type of computation or manipulation or transformation of data represented as physical, e.g., electronic, phenomena which may occur or reside e.g., within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program such as but not limited to a general-purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “registering”, “detecting”, “associating”, “superimposing”, “obtaining”, “providing”, “accessing”, “setting”, “identifying”, “browsing”, “removing”, “storing” or the like, may refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices, or may be provided to external factors, e.g., via a suitable data network. The term “computer” should be broadly construed to cover any kind of electronic device with data processing capabilities, including, by way of non-limiting example, personal computers, servers, embedded cores, computing systems, communication devices, processors (e.g., digital signal processors (DSPs), microcontrollers, field programmable gate arrays (FPGAs), application specific integrated circuits (ASICs), etc.) and other electronic computing devices. Any reference to a computer, controller, or processor, is intended to include one or more hardware devices e.g., chips, which may be co-located or remote from one another. Any controller or processor may, for example, comprise at least one CPU, DSP, FPGA, or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and, alternatively, may be the same structure. A statement that an element or feature may exist is intended to include (a) embodiments in which the element or feature exists; (b) embodiments in which the element or feature does not exist; and (c) embodiments in which the element or feature exist selectably, e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage, e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s, e.g., as described herein which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user, e.g., by the system display, and receives and processes and/or provides to other modules herein, data entered by a user, e.g., using her or his workstation/device.

### BRIEF DESCRIPTION

Example embodiments are illustrated in the various drawings. Specifically:

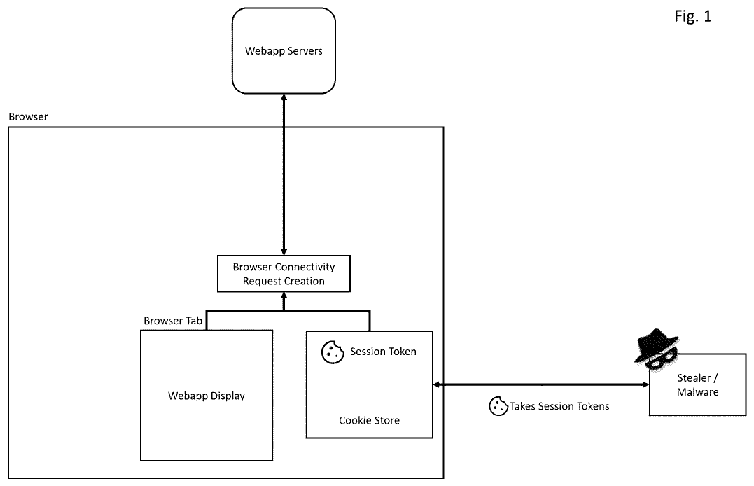

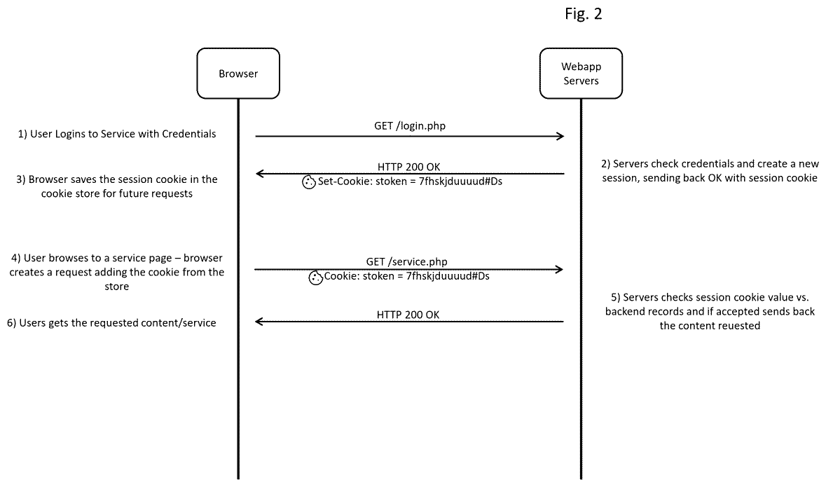

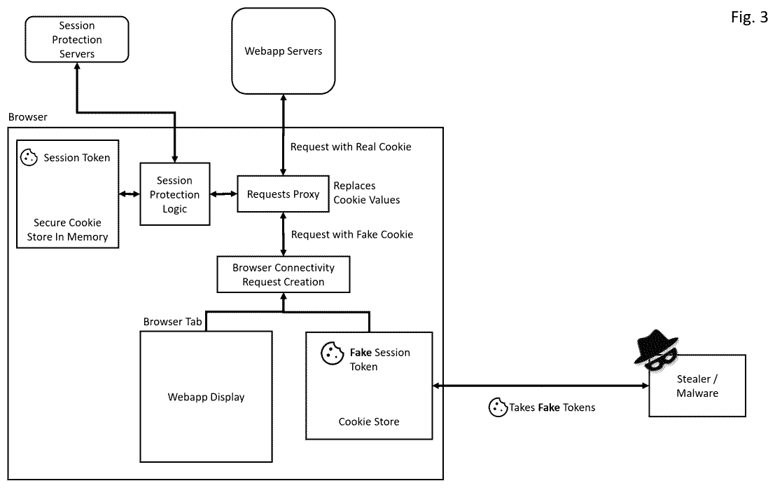

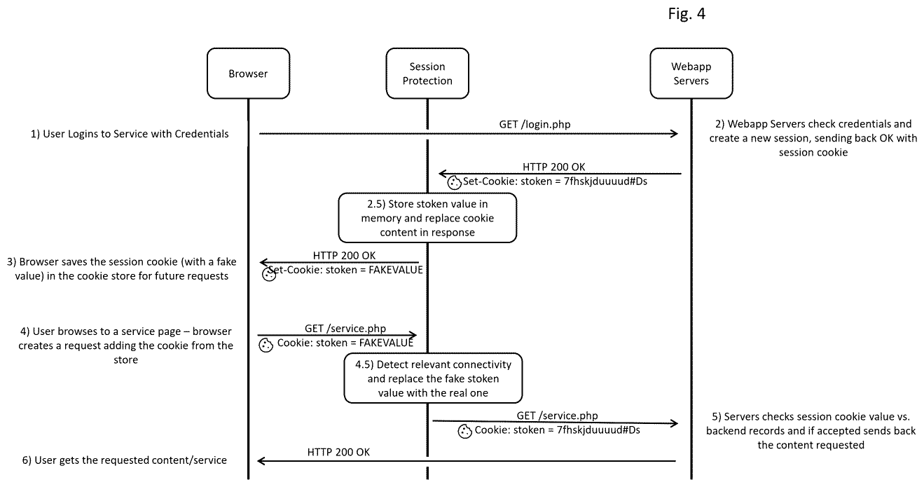

FIGS. 1-4 illustrate embodiments of the invention (FIGS. 3, 4) as compared to conventional browsing schemes (FIGS. 1, 2). In FIG. 4, operations 1-3 may be performed in the course of a login process, in which the user creates a new session with a webapp and an analyzer, according to embodiments herein, detects this and replaces the cookies accordingly. All or any subset of operations 4-6 typically occur during a request-response communication to a webapp or service, such as, say, Facebook, and include replacement of the fake cookie previously stored in the cookie store, by the system of the present invention, with the real cookie. This typically occurs each time it communicates with the service.

Certain embodiments of the present invention are illustrated in the drawings; in the block diagrams, arrows between modules may be implemented as APIs, and any suitable technology may be used for interconnecting functional components or modules illustrated herein in a suitable sequence or order, e.g., via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language, or may comply with any conventional query language or protocol.

Methods and systems included in the scope of the present invention may include any subset or all of the functional blocks shown in the specifically illustrated implementations by way of example, in any suitable order, e.g., as shown. Flows may include all or any subset of the illustrated operations, suitably ordered, e.g., as shown. Tables herein may include all or any subset of the fields and/or records and/or cells and/or rows and/or columns described.

Computational, functional, or logical components described and illustrated herein can be implemented in various forms, for example, as hardware circuits such as but not limited to custom VLSI circuits, or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences, such as but not limited to objects, procedures, functions, routines, and programs, and may originate from several computer files which typically operate synergistically.

Each functionality or method herein may be implemented in software (e.g., for execution on suitable processing hardware such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with: methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC, or DSP, or any suitable combination thereof.

Any hardware component mentioned herein may in fact include either one or more hardware devices e.g., chips, which may be co-located or remote from one another.

Any method described herein is intended to include within the scope of the embodiments of the present invention also any software or computer program performing all or any subset of the method's operations, including a mobile application, platform, or operating system e.g., as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use, and which is based on any suitable technologies such as semiconductor, magnetic, optical, paper and others.

### DETAILED DESCRIPTION OF CERTAIN EMBODIMENTS

Active protection is provided herein for web browser users to protect their social and any other cookie-based session authentication online accounts from malware/stealers that abuse session cookie hijacking.

The cookie store is the code module that handles the storage of cookies in conventional browsers. The cookies are typically stored for persistency on files as part of the browser files—in some cases plaintext, in other JSON files or an SQL database, depending on the implementation. Persistency is gained using files on the file system. Encryption may, in many cases, be added to these files, but, in certain browser solutions this encryption may be managed such that the needed decryption key may be accessed (e.g. by stealers) by reading another file from the browser. Thus, in practice, the files are stored without any adequate encryption or protection. This enables stealers to take these files, decrypt them quickly, and send back all the cookie values to their own servers.

The term “cookie” (e.g., “xs” cookie) as used herein is intended to include data which a user device's browser has received, e.g., as an HTTP response, from a website/service/webapp (e.g., Facebook). A cookie is typically stored on a user's device's browser and is typically sent, e.g., by the browser to a webapp server to enable the webapp to automatically verify the user's identity and access permissions. A stolen cookie(s) is useful to an attacker for stealing the user's identity and access permissions, inter alia. The term “real cookie (value)” as used herein is intended to include a value which, when sent by a device's browser to a given web service, results in valid communication of that browser to that service. The term “fake cookie (value)” as used herein is intended to include a value which, when sent by a device's browser to a given web service, does not yield valid communication of that browser to that service.

A “Session Cookie” is a cookie (like “xs” in the case of Facebook, at the time this patent application is being filed) whose value is being used as a token (“session token”) for a current session. Session cookies typically store session tokens (which may be used for identifying and authenticating the user) for webapps, as opposed to cookies for other purposes, such as advertisement tracking cookies or site configuration cookies. These tokens or “cookie values” typically comprise a string, generated by the webapp servers for a given user, but not for any other user of the same service, hence it is unique, and is used as an authentication value for that user's session e.g. typically to grant a given user, who has provided relevant credentials, with time limited access to the user session and to prevent such access from any users who have not provided the credentials. Once created by webapp servers and sent to user's browsers, such tokens are typically delivered back to servers of the service (e.g., are presented by users to webapp servers) as cookies in each future communication between the user's browser and the webapp server. Typically, such tokens comprise persistent data stored on the browser (typically until an expiration time stored on a cookie has occurred, at which time the browser does not use this persistent data anymore, and, instead, deletes this persistent data from the browser's cookie storage.)

One of the most prominent and widely used cyber attacks these days is “Stealers”-a small piece of malicious code (malware) that usually hides in other applications or downloaded content, and typically scans and/or decrypts and/or extracts all available private data from the infected computer, sends the private data to the attackers, and typically vanishes from the infected computer. The compromised data may include private documents that the user has on the system, yet the focus is usually on any long-term highly monetized information those threat actors can take such as users' private social accounts and other online accounts that may include money credits (for advertisement), high profile and reputable business pages, and presence in social media, as well as financial accounts, business information systems with company Intellectual Property, etc. This is one “successful” approach that directly targets the hijacking of currently open and authenticated sessions of the victim's browser to those services. This way, there is no need for credentials, and this bypasses any multifactor authentications if these are being used.

The latter may be accomplished by extracting the cookie's data from the cookie store or browser's folder on the file system, which is used to protect this data by conventional web browsers yet nonetheless may be relatively poorly secured relative to embodiments herein which provide greater security against stealers. Those cookies (and specifically their values) are typically generated specifically for the user after being authenticated on the servers of the specific service (e.g., Facebook) and later may be used on any communication from the browser to the service servers, because this keeps the authenticated session alive and, conveniently for the user, does not require the user to keep on providing credentials and re-login each time. In many cases (Facebook and other similar social networks included) those cookie values remain active and relevant for months, years, and even for an unlimited time. With these cookie values, the attacker, e.g., via the stealer malware, can recreate the same session and play back the exact communication with that service server, as though the attacker is the actual authenticated user.

Getting the cookie content from the filesystem is unfortunately a far too simple task for Stealers (some are even open-sourced). Certain embodiments herein provide a technology which serves modern browsers and which improves their security by keeping those specific cookie values in a safer place to keep those accounts from being hijacked from outside of the browser.

The system herein is typically configured for creating an alternative route of cookie setting and use, which may be dedicated for session cookies only, or for cookies storing tokens only, that will not allow stealers or any other code from outside of the browser to read and grab or steal these cookies' values. This may be done by actively removing and/or hiding cookies, e.g., session cookies from the cookie storage of the browser, and later appending the cookies (from a better-secured secret stash which may be provided by solution code according to embodiments herein) to relevant requests each time this is called for or needed.

The terms “cookie” and “cookie value” may be interchanged in this specification e.g., in the above, entire cookies may be removed, or only those cookies' values or tokens, which provide users (and attackers) with access to webapp accounts, may be removed.

The term “cookie store” as used herein refers to a memory location and/or a local file system storage, in which a user's browser stores at least one cookie which the browser has received, e.g., as an HTTP response, from a website/service/webapp and from which the browser subsequently retrieves a cookie to send out to the same website. For example, Google Chrome and Microsoft Edge may store cookies in a memory location, e.g., file with a given name, within a user's Default folder, whereas other browsers may store cookies in a memory location within the user's Network folder.

It is appreciated that absent embodiments herein, the cookie subsequently retrieved by the browser is the very same cookie earlier stored by the browser, since the browser is configured to send to the website, later, the cookie received from that website, earlier. In contrast, when the system herein is operative, the “outgoing” cookie subsequently retrieved by the browser is not the same cookie earlier stored by the browser. Instead, the browser-retrieved outgoing cookie may be a fake cookie which differs from (e.g., was placed in the cookie store by system code on the device to replace) the cookie the browser stored in the cookie store earlier. Or, the cookie may be entirely absent from the cookie store. The system herein typically intercepts the fake cookie the browser is configured to retrieve from the cookie store and to send out and instead typically sends out, to the webapp, the real cookie, which is stored not in the cookie store, but elsewhere. The system may intercept relevant communication to a webapp/service/website whose cookie was earlier manipulated by the system (e.g. any request which includes a cookie which (each time such a cookie appears in an incoming response) the system is configured to remove and replace) and ensure the request is filled with or modified to include the cookie value originally sent by the webapp before the request is sent out to the webapp. This may occur each time the value is totally missing due to the system herein having removed the value from the cookie store, e.g., upon initial retrieval, and/or each time the cookie value is empty and/or each time the cookie value is replaced, by the system herein, with a fake value.

Thus, for each relevant service, the system may track all the session cookies being used and may activate the system operation on one or more specific cookies (e.g., Facebook's “xs” cookie) that are pre-known to the system, or store crucial identifiers of that specific user and/or the associated session.

Once those targeted cookies are set (typically following initial login to the service) the cookie content may be hidden (stored elsewhere, typically more securely) and may be replaced by a fake (e.g., random generated/spoofed) value that may continue with the general flow and may be stored on the local cookie store. The real, secret value, of those cookies may be kept in a location known to the solution code, e.g., an extension of the browser or any add-on code which may be executed as part of the browser.

The secret cookie content may be stored on memory, e.g., sandboxed in the context of the browser process, thus becoming inaccessible to stealers/malware running from outside of this context. Conversely, this content (e.g., token) is typically never stored in the cookie store local files as managed by the browser. As a result, mainstream session cookie stealers become unable to steal the session cookie value for browsers in which the protection mechanisms shown and described herein have been installed/activated.

The solution code typically includes an analyzer which may detect all needs to use protected values e.g., session cookies as part of the browser's real authentic communications with a given webapp or service. Each time such a need (e.g., indication of an upcoming HTTP request) is identified, the solution code may step up in the browser's stead, and may inject the real value of the cookie into the outgoing request/s. Those requests would otherwise be generated by the browser following the user interaction with the platform/service which may be supported or protected. If a false/fake cookie value is injected by the solution, for example, the solution (e.g. the solution's HTTP communication analyzer) may detect the use of this false value by the browser in a soon-to-be-sent request, and, after checking this is a genuine request to the service provider, may replace the content of the cookie, e.g., in the outgoing request headers, and release the request to the webapp server, where the request, as released by the solution code's controller, may include the real cookie value, rather than the fake value injected by the solution into the cookie store that the browser is accessing.

During the active session, the solution may monitor any changes or refreshes being made with the session cookie and act accordingly, e.g., the solution code may act as follows in special situations or cases such as session refresh, logouts, time-outs.
Session refresh—each time the webapp server refreshes the session and generates new security tokens or other unique identification or authentication values, the solution may update the relevant value and may replace the false value of the cookie.
User requested Logout—if the user requests to logout, the solution (e.g., the solution code's analyzer) may detect this and the solution's controller may ensure the cookie value is deleted to prevent the no-longer-in-force cookie, which the solution previously safely stored, from being sent out again post-logout.
Forced Logout—each time the webapp server enforces a logout (e.g., in cases in which the user is ordered to close/revoke the session from another platform or changing a password), the solution analyzer may detect this, and the solution controller may remove cookies accordingly.
Cookies Timeout—in case the relevant real cookie has reached its expiration time as enforced and set by the webapp server, the solution may remove the real value in accordance with, or responsive to, the browser removing the fake cookie from the store to retain general functionality, and may allow the webapp communication to reach relevant login or authentication flows as needed generally in this case.

All the above is typically done while the real cookie value is stored other than in the cookie storage e.g. in the Browser Process's memory in the solution context, although it is appreciated that alternatively or in addition to saving the real value in the browser memory, the system may save the real value in any secure process which the browser/extension are able to access or communicate with. To regain persistence, the encoded/encrypted cookie value may be saved on persistent storage so the solution may work even if the browser is shut down and restarted. Typically, the storage utilized by the system code is always outside of the cookie store, typically according to the selected method of integrating the solution into the browser, e.g., as an extension, plug-in, new code module etc. Some relevant storage options are as encrypted files on the file system and/or on the extension local storage as managed by the browser's extensions mechanism, etc.

The cookie value may be encoded/encrypted using any suitable encryption scheme such as but not limited to:
Online—The cookie value may be encrypted with strong encryption. The key for the encryption may be retrieved by authenticating to the solution itself (e.g., the user account used for the product that integrates any embodiment shown and described herein). Using this authentication, the solution may retrieve the relevant key to decrypt the locally stored cookie e.g., on browser init. Typically, the cookie value (whether encrypted or decrypted) is never submitted to any server of the solution or any other 3rd party server not relevant for the specific webapp service.
Offline Encryption—The cookie value may be stored encrypted with strong encryption, and (e.g., on browser init) the user may be requested to provide a PIN code (or other password) to decrypt the value and store the value on non-persistent memory. The password/PIN code may be provided by the user upon initiating of the solution, and the user may have to remember it. If a password is lost, the user may have to login again to the service and generate a new session.
Offline Static—the cookie value may be encoded and obfuscated e.g., using metadata relevant specifically for the user, such as user ID and/or machine ID and/or other account details, and may be decoded on initiation of the browser directly to the non-persistent memory.

More generally, it is appreciated that solution code herein may operate client-side and does not require a server-side to which users have previously onboarded. For example, the solution code may support an “offline” (100% client side) option in which no server side exists. In this server-less case, users are typically required to create and remember a passkey/PIN to decrypt cookie values once their device's browser is restarted, as opposed to previously onboarded users in an “online” embodiment having a server, in which case system authentication may be used to decrypt the cookies such that no password/PIN needs to be remembered.

It is appreciated that webapps like Facebook have “tokens” (e.g., for Facebook “user access token” or simply “access token”) each typically comprising a unique (to a given webapp account) string or value which may be generated by the webapp server, typically on login, and which may be used as an “access key” which alone (or combined with other identification, not secret data from other cookies) enables a user to access her or his account. The token may be used as the identifier and/or authentication for a specific user to its webapp service thus serves as a temporary (e.g., may expire) access-key to the account. It is temporary, as it may expire, as mentioned above. But as long as it is valid, this is the only thing the user needs to access the account (e.g. no need for password entry).

This token enables a given webapp user to access her or his profile and/or identity. Webapp users who have the token uniquely associated with a given webapp account, can access that account (e.g., profile and/or identity). While there may be other ways to access the account, e.g., using credentials and other authentication methods, once the token is in the account owner's (or anyone else's) possession, this is all that is needed to access the account, with no need to remember or know username and password, or successfully pass any 2FA (2-factor authentication) flows. Unfortunately, this means that if a malevolent other obtains e.g., steals a user U's token, this attacker may be able to directly access user U's account-typically without the need for user U's username and password, and usually also without the need of any other multi-factor authentication methods, even if these are applicable. Conventionally, each such token is stored as a “value” in a cookie in the “cookie store” of each user's browser. The system herein is typically configured to retrieve this value from the cookie store, store this value on secure solution memory instead, and then, each time this value is needed, the system herein retrieves this value from secure solution memory, and produces the value as retrieved, which is real, and not a fake value that may have been injected by the solution, as a honey-pot style counter-defense method, in the cookie store.

Each cookie typically has a name. It is appreciated that in addition to pairs of character strings, a user device's browser is also configured to save, in a given cookie, additional cookie metadata or cookie parameters such as, say, time of cookie creation, cookie expiration time, security related parameters, and the domain address the cookie is related to.

For example, “xs” is the name of the cookie which the Facebook webapp uses to store its token, and in which, at the time this application is being filed, the following metadata is saved. It is appreciated that the Value field is merely an example, and that various parts of this string may be used to store various respective attributes.

| | Metadata: | Metadata: | Metadata: | Metadata: |
|---|---|---|---|---|
| Value example | Domain | Path | Expiration | Security |
| 11:uBaVilaLu10iA:9:758493757:- | .facebook.com | / | Fri Sep 07 | Secure; |
| 2:18775::AcFVfgVfyf4fJfQfRfYfQf- | | | 2024 | HTTP |
| fBfKfSbPAhEiGWCQBxvhPP | | | 09:10:19 | Only |
| | | | GMT | |

Embodiments herein are applicable to webapps or services that use Session Cookies to maintain a working authenticated session between their service and a user's browser, using browser cookies to keep a security token in browser storage, and use that token, in each communication with the webapp server, to validate user authenticity, and, responsively, to provide secure information back to the user. This token is created by the service once the user authenticates using credentials vis à vis the service (e.g., username password and perhaps multi-factor authentication), and may be saved locally on browser cookie storage and also on service servers. This token, once saved as a cookie, is automatically added by the browser to any request the browser sends to the service domain, allowing the servers of the service to validate the request and send back the secured content. It is appreciated that Facebook, mentioned herein by way of example, is but one such service. Other such services include but are not limited to LinkedIn, Instagram, and YouTube.

These services are convenient, hence popular, because they enable users to keep on browsing their web service (e.g., social network) pages or accounts without bothering to enter their name and password each time they restart their browser/device, and keep the session live and authenticated for days, and even months. The service can choose to keep those tokens valid for a pre-configured time. Once the time is over, the webapp server may revoke those tokens, and if the user's browser then sends the old revoked token, the browser may be redirected back to the login page to re-create a new authenticated session followed by new tokens. The token revocation is handled on both sides—the webapp server may revoke the token and also the cookie on the browser, once created, is configured with a validity period set by the webapp server (e.g., expiration date and time). So the browser itself can also revoke the cookie automatically. Many of those webapp servers also handle automatic token renewal, which may be referred to as “Token Refresh”, in which the token itself is replaced with a new generated value and the expiration date may also be updated to a later date and time, all carried out without user interruption to any action needed. Also, various such webapp servers provide a logout functionality-a specific page that, once loaded, orders the webapp server to revoke the session token and requests the browser to delete the cookie. Other ways to revoke the session may apply with some services in a remote manner, e.g., by providing a session management capability to allow user to log out a session on another device remotely (as if visiting the logout page from the device as described above).

The system herein typically includes an updateable table or configuration file of different cookies, created by different webapps, which store tokens which may grant users access to her or his account in respective web apps. This table may, for example, be stored on the client i.e., user device's browser. The table or file may store all relevant cookie names, webapp domains, webapp URLs, relevant error codes and responses to trigger certain flow activities like logout or token refresh etc. The file may, for example, include for each such cookie, the cookie's name and/or an identification of where within each cookie the token is stored. This table or file may be updated each time the token location within a given cookie (or a given cookie's name) is changed by a given webapp. For example, a cookie named “xs” is used by Facebook and the table may stipulate where the token is stored in Facebook's “xs” cookie by indicating, say, that the “xs” cookie includes a 1 or 2 digit session numbers or a string, followed by a colon, followed by a session secret or token, or in other cases the entire string value of that cookie. If this webapp (say Facebook) begins using a comma rather than a colon, or the session number becomes longer or shorter, then the system herein may update the table or configuration file to reflect this, either via the system's server side, or by updating solution code on clients, using a version update. This configurability typically ensures that any cookie name may be added to a list of cookies maintained for each service domain or webapp, which are the cookies which are to be monitored, for cookie replacement purposes, by the system.

Thus each webapp may use any suitable cookie/s with any suitable name/s and corresponding domains to uniquely identify each user's browser to the webapp, and may change the cookie name (and/or syntax) anytime, and/or may use more than one cookie for this purpose, since the system is typically configurable to keep this data up to date for all supported webapps; typically, the solution code has access to an updateable list of cookies, names, syntax, for the service domain of each supported webapp.

Thus, the system is configured for enhancing security for users engaged in browsing activity via respective browsers installed on users' respective devices, and comprises:
a. An HTTP communication analyzer which analyzes HTTP responses incoming to a user's device from webapp/s servers and/or HTTP requests outgoing from the browser on a user's device to web apps servers, including identifying incoming cookie values (aka real values) being sent, e.g. in HTTP responses, from web app/s servers to the browser and outgoing cookie values being sent, e.g. in HTTP requests, from the browser toward web app/s servers; and/or
b. A Cookie Store Monitoring and Management Solution (aka cookie monitor/manager)—analyzes cookies already stored by the browser (to handle already active sessions) as well as cookies being read or written into the cookie store to detect abnormal or normal activities of session cookies usage in the browser. Moreover, this module is typically configured to manage cookies already stored by altering their values to a fake generated value, create or remove the cookies in relevant cases e.g., as described herein, and/or:
c. A controller which, responsive to at least one incoming cookie having been identified by the HTTP communication analyzer or the cookie store monitoring, stores the incoming cookie value in a location other than the user device's browser's cookie store, and/or deletes at least the incoming cookie value from the user device's browser's cookie store, thereby to store at least one real value only outside the cookie store.

The analyzer, management solution and controller may all be implemented as solution code on hardware processor/s.

Typically, the controller at least once adds at least one real value outside the cookie store to at least one service message request outgoing from the user device's browser toward at least one web app.

It is appreciated that identical solution code may be installed on the browsers of each of many different browser and webapp users respectively.

Typically, the analyzer and/or controller and/or cookie monitor/manager described above reside on the device. The cookie manager may have cookie generating functionality (aka cookie generator). Any suitable characteristic/s of incoming cookies may be identified by the HTTP communication analyzer as well as the cookie monitor/manager, such as the cookie's name and/or value. The controller may have access to an updateable table in memory which may store names (and/or other identifiers) of all cookies used by webapps (which may be used by the browser) which store tokens giving access to webapp accounts. For example, e.g. in solution configuration as described elsewhere herein, the “value” of the “xs” Facebook cookie which stores these tokens at the time this patent application is being filed, may be stored in a configurable table which may be updated each time Facebook (say) changes the way they use the cookies e.g. changes the location or field within the cookie at/in which the token is stored.

Deletion of the incoming cookie value from the user device's browser's cookie store may be achieved or augmented by setting other values and/or parameters instead under the same cookie name and domain in the cookie store. Deletion may also comprise removing the cookie's record entirely from the user device's cookie store.

Event listeners for the various stages of making an HTTP request, which receive information about HTTP requests and/or modify and/or even cancel HTTP requests, are known, e.g. as described here https://developer.mozilla.org/en-US/docs/Mozilla/Add-ons/WebExtensions/API/webRequest and may be used by the analyzer typically in accordance with selected possible implementation methods.

As an example, implementing this type of analyzer as part of a Chromium-Based Browser Extension, It is appreciated that web request API's, such as the chrome.webRequest API, may be used by the analyzer to observe and/or analyze traffic (e.g. HTTP messages between web apps servers and user devices' browsers such as HTTP requests from browser to webapp server and HTTP responses (e.g. set-cookie) sent from webapp server to browser) and to intercept and/or recognize and/or block and/or modify certain requests outgoing from a browser toward a web app in-flight, e.g. as described here: https://developer.chrome.com/docs/extensions/reference/webRequest/. Web request APIs are typically provided by browsers e.g. any Chromium browser to extensions, typically once permission to use a web request API is requested and approved. For example, permission to use a web request API may be requested from and approved by the Chrome Store (Google) or by the Addons Store (Microsoft Edge). Many Chromium based browsers are known e.g., as listed here: https://alvarotrigo.com/blog/best-chromium-browsers/and an extension which has gained WebRequests permission can then act as a proxy to any HTTP request and/or any HTTP response. This type of extension may remove incoming cookies and store them securely rather than in the browser's cookie store, may store a fake value in the browser's cookie store, and may retrieve the securely stored “real” values and inject them into outgoing cookies.

The communication analyzeraka proxy typically receives full access to the Headers of any HTTP request and/or any HTTP response and performs HTTP communication analysis to identify incoming and/or outgoing cookies which then enables the solution to set and send cookies and/or more generally, to store and/or delete and/or replace cookies e.g. as described herein.

Alternatively, or in addition, another method which may be used is to manage the cookie store directly e.g. to delete real values and/or restore real values and/or update cookies with generated values, also by using relevant API permissions in case of extension implementation like using the chrome.Cookies API (https://developer.chrome.com/docs/extensions/reference/cookies/). Alternatively, or in addition, listener methods may be used which are typically triggered each time a cookie is accessed to ensure the correct cookie value (correct value of the token giving webapp account access), rather than a fake value of that token, is stored or read. This may also be accomplished using relevant permission and API as described elsewhere herein, e.g., typically only after permission to use a web request API and/or Cookie API is requested and approved.

Typically, the controller adds the at least one real value outside the cookie store to the at least one service message, responsive to a relevant service request having been identified by the HTTP communication monitor. For example, the controller may add the at least one real value outside the cookie store to the at least one service message, responsive to at least one outgoing cookie value having been identified by the HTTP communication monitor.

It is appreciated that the analyzer monitors requests being sent out from the browser to servers of the relevant webapp e.g. by checking any suitable characteristic/s of these requests e.g. all or any subset of: target domain of request and/or the type of request (text, media etc.) and/or the request path on the domain (e.g. the full URL of the request) and/or the origin of the request and/or initiator, and/or the headers types and/or values and/or cookies being added to the request by the browser. Typically, the specific request characteristic/s which are checked is configurable, e.g., may differ, depending on whether the supported service or webapp is Facebook or others.

Cookies set by a webapp such as, say, facebook.com are visible (typically only in requests sent by browsers back to the webapp server of (say) facebook.com. It is appreciated that the system is configured to prevent any leakage of real cookie data to other malicious sites which might request data from webapp servers supported by the system herein. For example, the system may be configured not to add real cookie data to any request that might be seen by a 3rd party other than the intended request recipient (other than the real webapp server e.g.).

It is appreciated that in certain cases, the system's client may get specific data/behavior that indicates a need to revoke a given user's cookie or update the user's cookie.

Typically, the system handles any special cases (e.g., handling a revoked session) which are needed to ensure that other functionality is not broken.

For example, all or any subset of the following cases may be handled;
descriptions of which APIs may be used to implement actions needed in each state, assuming by way of example that a Chrome extension implementation is used, are now provided:
i. General Normal Flow—alters fake/null value of cookie in HTTP requests to retain authenticated and valid session as usually used in the relevant webapp protocol. For a Chrome Extension implementation, this may be implemented using the WebRequest API to both set a listener to capture the request before being sent and to modify the relevant headers with the correct cookie value.
ii. Session creation—following login to a web app, or session refresh by the webapp servers, the solution may update the new relevant cookie values set by the webapp servers on the solution storage and may ensure cookie values and metadata in cookie store is correct (e.g., metadata updates while the value is set to fake). For a Chrome Extension implementation, the WebRequest API may be used to catch the response and read cookie-set header values, and the Cookies API may be used to facilitate reading and changing cookie values from the store as well as setting listeners where cookies.OnChanged may be used to capture events of cookie creation, deletion or updates.
iii. Session end—each time user requests to logout, or a session logout is imposed on server side, this may be detected by the HTTP analyzer with relevant indicator per webapp, e.g. authentication error code in HTTP response, or setting a magic value to a cookie like “deleted” in set cookie response, or redirecting to login page of the service, etc.). Once a relevant indicator is detected, the system may delete the real cookie and/or the fake cookie from the cookie store and may direct the user to login page. It is appreciated that here and elsewhere “delete cookie” may comprise deletion of a token or string, which may be stored within or as a cookie, and which serves as an access-key providing access to a given webapp account. Similarly, other operations, such as “update”/“refresh” (“update cookie”) may comprise updating a token or string, which may be stored within or as a cookie, and which serves as an access-key providing access to a given webapp account. For a Chrome Extension implementation, the WebRequest API may be used to catch the response and read cookie-set header values, and the Cookies API may be used to facilitate reading and changing cookie values from the store as well as setting listeners where cookies.OnChanged may be used to capture events of cookie creation, deletion or updates.
iv. Cookie expiration/deletion-if cookies, e.g., relevant session cookies or cookies which store tokens providing access to a given webapp account are deleted from the browser by the user or 3rd party software, or the cookie expiration date was reached, the system's controller may, responsively, delete the real value of the same cookies from its internal storage, or more generally may follow the same rules the real cookie store follows. Typically, the user will then have to re-login as usual.

In a Chrome Extension implementation, the Cookies API may be used to facilitate reading altering or completely deleting cookies from the store as well as setting listeners where cookies.OnChanged may be used to capture events of cookie creation, deletion or updates.
v. Mid-session-activating the solution once there is an active session already running. The real cookie may be read directly from the cookie store and may be stored in the secure location, and a cookie in the store may be updated to the fake one. Typically, the solution e.g., Cookie Store Monitoring and Management Solution herein is configured for monitoring which type of cookies are available in the cookie store on solution activation. For example, the cookies which a webapp stores may depend on various parameters, e.g., whether or not the user is registered, or whether or not the user is logged-in or logged-out, etc.

Thus the solution may monitor whether user/s are currently registered to which webapp/s, and which webapp/s, if any, are they logged into, depending on which type/s of cookies are, typically upon solution activation, available in a given user's cookie store.

In a Chrome Extension implementation, the Cookies API may be used to facilitate looking for, reading and/or altering cookies from the store.
vi. Solution disable-if user requests to disable the solution, it may set real values of cookies back to the cookie store, deleting the values from solution memory.

In a Chrome Extension implementation, the Cookies API may be used to facilitate looking for, reading, altering and/or deleting cookies from the store.

### Example Implementations May Include any/all of

The user requests to log—out e.g., (in many services or webapps) by entering a specific page, clicking on the logout button etc., different webapp servers respond to such requests in different ways, e.g., by revoking the cookie value on the server side and/or by sending the user to the webapp login page and/or by sending a cookie-deleted value back to the end-user's browser, to indicate the change. Typically, the system analyzer is aware of how different webapp servers respond to such requests and the solution code's analyzer may look for these characteristic behaviors. Each time these behaviors are indicated, the real cookie value is cleared from system memory (e.g. from the client memory on the relevant user's device) and the fake value generated by the system is deleted from the device's cookie store.
The server ends the session—which may be initiated by the webapp server for various reasons, and/or by the user, e.g., if logged in to the webapp from another device and chooses to end the session of the device enrolled with the solution of the present invention for some reason. Typically, the solution's client side identifies such a session end by detecting that an error return code (e.g., 401 unauthorized) is sent back on the first try to communicate with the revoked cookie value. Responsively, the real cookie value is cleared from solution's system memory (e.g., from the client memory on the relevant user's device) and the fake value generated by the system is deleted from the device's cookie store. The user is typically sent back to the login page.
The server requests to refresh the session—which some services do on occasion, e.g., as a security measure. Typically, the system's client side identifies such session ends by detecting that a new cookie value has been sent back, typically with a parameter indicating this is a refresh. Responsively, the new cookie value is stored as a new real cookie value, and a new fake value is generated by the system and placed in the device's cookie store, instead of the fake value that was generated for the real cookie value that preceded the new cookie value. The next communication may thus use an updated cookie value.
User clears cookies—each time the user deletes relevant cookies from the browser, the system typically deletes the existing fake value from the cookie store, but typically retains the real value in the solution code's memory. Thus, responsive to the user request, the system controller is typically configured for deleting the real cookie value from the solution code's local storage, just as the browser's own cookie store does.

Example: FIGS. 1-4 compare a conventional scheme by which browsers handle session cookies (FIGS. 1, 2), which enable stealers, external to the browser, to obtain cookie values, to a scheme according to certain embodiments (FIGS. 3, 4) in which a scheme according to embodiments herein is activated, and, responsively, provides a new layer of session cookie management and protection to prevent malware/stealers from taking “real” cookies, typically by removing the “real” cookies from the exposed cookie storage aka cookie store, while storing non-real (hence unusable) cookies in their stead. Typically, solution code is provided which is configured for detecting session cookie setup between a webapp or service and a browser, and/or for ensuring future communications are handled correctly using the managed session cookie stored in a memory location other than the exposed cookie storage.

For simplicity, one user's browser is shown, however, in practice, W webapp servers supported by the system may interact with U users' browsers. Typically, (identical) solution code is installed on each user device's browser which protects the user's device's cookies which may be issued by any of the W webapp servers.

FIG. 1 is a conventional set-up, vulnerable to stealers, which includes webapp servers communicating with a browser. FIG. 2 is a message flow diagram depicting a conventional flow of requests, between webapp server and user's device's browser. FIG. 3 is a set-up according to certain embodiments which is not vulnerable to stealers, and FIG. 4 is a message flow diagram depicting a flow of requests between webapp server and user's device's browser, for the set-up of FIG. 3. All or any subset of illustrated elements of the embodiment may be provided in practice.

In FIG. 4, operations 1-3 depict a login process, in which a user logs into a webapp and creates a new session vis à vis the webapp. Solution code implementing embodiments herein detects this and replaces cookies accordingly (e.g., replaces real value in cookie store with fake value). Operations 4 onward represent a request-response communication to the webapp which includes replacement of the fake cookie with a real cookie, on each subsequent communication between the browser and the service or web app. As described elsewhere herein (not shown), a user may also request to log out and end a session, or a session may be ended by the webapp server and/or the server provided in accordance with certain embodiments herein and/or a server (webapp server and/or the server provided in accordance with certain embodiments herein) may request to refresh a session and may replace session cookies with new ones. In each such situation, the solution code typically mimics the operation of the cookie store, e.g., as described elsewhere herein.

It is appreciated that generation of a fake value is optional since, alternatively, the cookie may simply be removed from the cookie store, or the real value may be replaced by a blank value or any other value including a random or uniform value. Alternatively, however, specific strings are generated as fake values, each which resembles whatever has been found, as part of system development or maintenance, to characterize the population of real cookies being used by a given webapp; this prevents attackers from easily concluding that they have not captured the real value, hence prevents such attackers or stealers from looking for the real value elsewhere. Typically, stealers do not know exactly how to recognize real cookie values since these are created by proprietary (secret) algorithms used by various webapps. However, the cookie generator may be configured to generate, for each web app, fake values with characteristics which resemble the population of real tokens generated by a given webapp, e.g., the value may be the same length as the webapp's real cookies, and/or may use the same character set and/or may have similar entropy.

According to certain embodiments, cookie detection/identification solution code resides on devices used by an organization's employees. Typically, this allows an IT/Security Manager to know what services are being used by each of the organization's employees. According to certain embodiments, management functionality may be added, e.g., enforcement of company policy to allow/disallow services, and/or forceful revocation of session cookies to all users each time a manager believes a breach has occurred, and/or forcing use of a secure cookie session on specific custom services or webapps used by company employees, and/or allowing usage of certain apps only when solution code providing security from stealers, e.g., as described herein, is active.

The “session protection” column in FIG. 4, according to certain embodiments, describes operation of on-premises solution code, e.g., browser extension running on each protected user's browser and configured to control cookie security by manipulation of traffic between the user browser and the server (e.g., replacement of fake cookies by real cookies). The solution detects active sessions to a service, and detects new logins to a service.

The flow of FIG. 4 may include all or any subset of the following operations:
Operation 1) User's device's browser logins to any service or webapp supported by solution code herein with her or his credentials, e.g., (if the webapp is Facebook) GET/login.php. Typically, login is per device, for a given user account, such that each authenticated session is device specific.
Operation 2) webapp servers check user's credentials and create a new session between user and supported webapp, including sending an OK message which indicates that the request was correct and which includes a session cookie-set command which is sent back to user's device as a response header, such as:

HTTP 200 OK
Set-Cookie: stoken = 7fhskjduuuud#Ds

It is appreciated that “Set-Cookie:” is the header of the HTTP response which enables the webapp server to request the browser to add a cookie which has a certain name and certain secret value/s including a session token aka real cookie value, to be stored in the user device's browser's cookie store. In the illustrated example, the cookie's name is “stoken” and the cookie's value which provides user with access to “his” session, is “7fhskjduuuud #Ds” by way of example.

Operation 2.5) Session protection solution code running inside the browser on user's device stores “stoken” value 7fhskjduuuud #Ds (the real cookie value in this example) in session protection memory or secure memory of the solution code typically inside the browser (typically after first encrypting this value) and replaces cookie content in response (e.g. substitutes a fake cookie value XXXXX for the cookie value 7fhskjduuuud #Ds sent by the webapp), such as:

HTTP 200 OK
Set-Cookie: stoken = XXXXX

It is appreciated that the cookie value as stored by the browser may be changed by manipulating the request itself before being handled by the browser. Alternatively, the solution code may change the value directly in the cookie store using the cookie management solution.
Operation 3) Browser saves the session cookie (fake value e.g., XXXXX) in the browser's cookie store for future requests.
Operation 4) User device browses to a service page-user device's browser creates a request adding the cookie (fake value e.g. XXXXX) from the browser's cookie store, e.g. (if the webapp is Facebook):

GET /service.php
Cookie: stoken = XXXXX

Operation 4.5) Session protection solution code detects genuine connectivity, i.e., between browser and supported webapp (as opposed to non-genuine connectivity with another entity entirely.)

Responsively, the session protection solution code replaces the fake stoken value XXXXX with the real one (with the cookie value 7fhskjduuuud #Ds sent by Facebook earlier). Typically, the session protection solution code retrieves the encrypted form of the cookie value 7fhskjduuuud #Ds sent by Facebook from session protection memory, decrypts it, and then replaces the fake stoken value XXXXX in the request created by the user device's browser, with the decrypted cookie value 7fhskjduuuud #Ds sent by Facebook, e.g. (if the webapp is Facebook):

GET /service.php
Cookie: stoken = 7fhskjduuuud#Ds

Operation 5) supported webapp's servers checks session cookie value vs. backend records, and, if accepted, sends the content response back to the user's device's browser with typically an HTTP 200 OK message with content. The solution code in the user's browser typically forwards the response to the browser, including its payload, for example the profile page that was requested by the user to be displayed on her or his device's browser, or other requested content.
Operation 6) User device gets the requested content/service.

According to certain embodiments, the system herein is entirely client-side and may run on the extension or other implementation methods inside the browser or outside of it. However, a server side may be provided, e.g., for registering and subsequently authenticating users, and/or maintaining telemetry/logs and/or configuration (e.g., adding more supported services and/or selectable activating or disabling the system herein), and/or to facilitate encryption and/or decryption of the real cookie, typically while ensuring persistency.

The telemetry/logs may be used to ensure the system receives indications that a given webapp or service has changed its cookies or the way its cookies are used, e.g., has changed the name of a cookie which stores a token which provides access to sessions, from x to y. Each time this happens, the system may change the configuration of the solution code on every user device's installation accordingly, e.g., so that rather than replacing content of outgoing cookies named x with a real cookie value, the system may, from now on, replace content of outgoing cookies named y with a real cookie value.

According to certain embodiments, the real cookie value is encrypted and the system herein authorizes the user to decrypt the encrypted value on a given device's browser, if the user successfully authenticates to the server (if the solution code has a server side) as the user associated with that device/browser. Typically, the solution server includes authentication functionality and stores user details typically provided when each user device onboards the solution server. A user which provides valid user details is then entitled to decrypt the real cookie value stored locally, in encrypted form, on his/her browser. Typically, the real value is stored on the filesystem to achieve persistency, such that even after the user shuts down her or his computer or browser, the real cookie value remains stored. To decrypt this value (if stored encrypted), the user may remember a password s/he was prompted by the system to create for the file storing the real value, and/or the user may use the authentication to the server. Once the user either provides the password or authenticates to the solution server, the encryption key to the encrypted real value on the user's device is retrieved by the server and sent to the user who can then decrypt the cookie on her or his local system, and retrieve the clear text real cookie value. It is appreciated that, typically, cookie values are stored client-side and are not sent to the server side (even encrypted) at any time.

Even if a server is provided, the server typically does not store users' private data like cookie values. Instead, the real value of the cookie never leaves the user's device; users' browsers' cookies are stored on-premise, e.g., the solution code/extension is configured for storing real cookie values described herein on the solution memory on the user's device, typically on volatile process memory rather than as a file easily accessible to outside processes, e.g., malware/stealers.

Typically, once the browser is shutdown (e.g., once the program process is exited) the real cookie value may be stored back on the file system, typically encrypted. Any suitable method may be used to encrypt/decrypt the cookie data, such as but not limited to those described herein. Server/s may store the decryption key and may provide this to the user's browser only after authentication and/or responsive to the user presenting a PIN code or personal password previously given uniquely to the user. Each user onboarding via the solution's server may be assigned an ID and/or an ID per each of his/her devices. A different encryption/decryption key may be created per each relevant device and/or for every user and may be used respectively by each user's device's browser itself to decrypt the real value of the cookie.

The system's client side may comprise solution code running as part of the browser or changing the browser's functionality. For example, the solution code may comprise a plug-in or code patch or add-on or browser extension (e.g. an extension to a browser already deployed in user device/s), or the solution code may be incorporated into a browser, e.g. as a module or feature, in the course of browser development, or the solution may be implemented as an external process to the browser with relevant permissions to analyze and modify any traffic incoming and outgoing from the browser, as well as access to cookie storage. For example, implementation of the solution code may include adding modules to Chromium (as an extension or directly added to code) or integrating with any suitable browser developer, such as, but not limited to, Firefox or Microsoft. For example, a Chromium Browser Extension add-on may be configured to add functionality, e.g., as described herein to a Chromium-Based Browser, such as but not limited to Google Chrome, Microsoft Edge, Opera, Brave, Vivaldi, given that Chromium is open source. Or, implementation may be based on Non-Chromium Based browsers like Safari or Firefox which provide extension APIs, or in general to any browser (off-the-shelf or self-developed) by patching code, adding code modules, self-compiling etc., depending on whether cooperation with official browser developers is available to gain access to code and directly add functionality to code.

If a server side is provided (if the system herein is not entirely client-side), any suitable connectivity between the system's client side and server side may be provided.

Any suitable technology may be employed to distribute a system as described herein to users. For example, a system which comprises an extension may be published to the Chrome Web Store.

It is appreciated that a cookie may contain only a session secret, or may include multiple information items, in addition to the session secret, which may be separated by (say) a colon (which may be encoded to the value % 3A for transmission). For example, the “xs” cookie may include:
first item-up to two-digit number representing the session number.
second item-session secret.
third, optional item-a ‘secure’ flag if the user has enabled the secure browsing feature.

Even if only some of the multiple items actually identify the user's browser to the web app which issued the cookie, the entire cookie value, rather than only the specific item which identifies the user's browser, is typically protected.

It is appreciated that services which use session cookies post-authentication to keep a live and authenticated session, usually create at least one cookie on the user's browser that includes some kind of value, or concatenated values, in some form of encoding, that once sent to the server will authorize the request and send back the valid result. These cookies are typically created responsive to a valid login process in which the user enters her or his user identification code (e.g. username/email address) followed by a password or any other form of validation (e.g. Code sent to email address, one time code sent by SMS). Once those login requests are sent out and validated on server, a response may be sent back, setting new cookies on the browser, at least one of which typically comprising a token that is subsequently sent again on any further request from this browser and responds with a valid response. To find the relevant cookies any one cookie at a time may be removed from any request (or altered) to determine whether, as a result, the session breaks or is revoked. Typically, a revoke of a session caused by sending wrong session cookie values is responded with a redirect to the login page (or any other error message) as well as responses requesting a browser to delete relevant session cookie values.

It is appreciated that the solution code herein may be advantageous since a stolen session cookie value enables a malevolent actor to hijack an end-user's social network account (e.g., post on Facebook or Twitter or Instagram, as an imposter), as well as other related accounts. Stolen session cookies may enable a malevolent other or hacker to steal the legitimate end-user's identity and prevent the legitimate user from using his own identity, by, say, replacing password/credentials in a given social network account and authenticating for digital services including financial services via the social network account, while preventing the genuine user from doing the same, thus facilitating identity theft and inflicting significant financial damage.

Also, if an end-user has a business page on a web app with advertisement credits representing money paid by the end-user to promote her or his content, hackers can use this to promote their own content and/or or sell this capability to others. Hackers can also steal an end-user's credit card if the end-user has added this to her or his account, e.g., to purchase more credits and/or to create more business pages allegedly belonging to the hacked end-user whose session cookie was stolen. A hacker can also use the end-user's identity for social engineering attacks, e.g., to communicate with the end-user's unsuspecting family or company employees, instructing them to take actions which are detrimental to these end-users and beneficial to the hacker, e.g., to export secret information that may reach the hackers, such as employees' computer passwords to the company network. The above are merely exemplary of the many attack vectors which are possible when conventional browsing activity occurs, and which may be rendered as not being possible when an end-user engages, instead, in browsing activity protected by any embodiment of the solution code herein.

Another advantage of certain embodiments may be that no cooperation with the webapp is required; the browser owner, aka user, may simply install and activate solution code herein without further ado. Thus, the solution herein typically operates on the vulnerable side (browser side) to prevent threats as described herein, and needs not rely on the webapp servers which create the vulnerability.

Another advantage of certain embodiments may be protection vis-à-vis type of stealer malware which comprises a malicious extension that uses Cookie API to copy all cookies and send them to a bad actor.

Another advantage of certain embodiments may be very wide applicability, since it is only a very rare user who disables use of all cookies (who modifies his browser's setting to decline cookies) since such a user is entirely unable to avail herself or himself of any of the many webapps/services that rely on cookies.

References herein to “said (or the) element x” having certain (e.g., functional or relational) limitations/characteristics, are not intended to imply that a single instance of element x is necessarily characterized by all the limitations/characteristics. Instead, “said (or the) element x” having certain (e.g. functional or relational) limitations/characteristics is intended to include both (a) an embodiment in which a single instance of element x is characterized by all of the limitations/characteristics and (b) embodiments in which plural instances of element x are provided, and each of the limitations/characteristics is satisfied by at least one instance of element x, but no single instance of element x satisfies all limitations/characteristics. For example, each time L limitations/characteristics are ascribed to “said” or “the” element X in the specification or claims (e.g. to “said processor” or “the processor”), this is intended to include an embodiment in which L instances of element X are provided, which respectively satisfy the L limitations/characteristics, each of the L instances of element X satisfying an individual one of the L limitations/characteristics. The plural instances of element x need not be identical. For example, if element x is a hardware processor, there may be different instances of x, each programmed for different functions and/or having different hardware configurations (e.g. there may be 3 instances of x: two Intel processors of different models, and one AMD processor).

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order, i.e., not necessarily as shown, including performing various operations in parallel or concurrently, rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g., in software, any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented, e.g., by one or more processors. The invention shown and described herein may include (a) using a computerized method to identify a solution to any of the problems, or, for any of the objectives described herein, the solution optionally includes at least one of a decision, an action, a product, a service, or any other information described herein that impacts, in a positive manner, a problem or objectives described herein; and (b) outputting the solution.

The system may, if desired, be implemented as a network, e.g., web-based system employing software, computers, routers, and telecommunications equipment, as appropriate.

Any suitable deployment may be employed to provide functionalities, e.g., software functionalities shown and described herein. For example, a server may store certain applications, for download to clients, which are executed at the client side, the server side serving only as a storehouse. Any or all functionalities, e.g. software functionalities shown and described herein may be deployed in a cloud environment. Clients, e.g., mobile communication devices such as smartphones, may be operatively associated with, but external to the cloud.

The scope of the present invention is not limited to structures and functions specifically described herein and is also intended to include devices which have the capacity to yield a structure, or perform a function described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis, e.g., triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware, or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous given the state or condition or data. Alternatively, or in addition, an alert may be provided to an appropriate human operator, or to an appropriate external system.

Features of the present invention, including operations which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to, those described in the Background section or in publications mentioned therein.

Conversely, features of the invention, including operations, which are described for brevity in the context of a single embodiment or in a certain order may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof, can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein, e.g., wired data communication and/or in short-range radio communication with sensors such as cameras e.g. via Wifi, Bluetooth, or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile, e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application and the description is intended to include apparatus whether hardware, firmware, or software, which is configured to perform, enable, or facilitate that operation or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry, including any such computer microprocessor/s as well as in firmware or in hardware, or any combination thereof.

It is appreciated that elements illustrated in more than one drawing, and/or elements in the written description, may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element, e.g., operation described herein, may have all characteristics and attributes described or illustrated herein, or, according to other embodiments, may have any subset of the characteristics or attributes described herein.

1. A system for enhancing security for users engaged in browsing activity via respective browsers installed on users' respective devices, the system comprising:
a. an HTTP communication analyzer, e.g., hardware processor which analyzes HTTP responses incoming to a user's device from webapp/s servers and/or HTTP requests outgoing from the browser on a user's device to web apps servers, including identifying incoming cookie values (aka real values) being sent, e.g., in HTTP responses, from web app/s servers to the browser and outgoing cookie values being sent, e.g., in HTTP requests, from the browser toward web app/s servers; and
b. a controller e.g. hardware processor which, responsive to at least one incoming cookie having been identified by the HTTP communication analyzer,
stores the incoming cookie value in a location other than the user device's browser's cookie store, and
deletes at least the incoming cookie value from the user device's browser's cookie store, thereby to store at least one real value only outside the cookie store;
wherein the controller at least once adds at least one real value outside the cookie store to at least one service message request outgoing from the user device's browser toward at least one web app.

2. A system according to claim 1 wherein the controller adds the at least one real value outside the cookie store to the at least one service message, responsive to a relevant service request having been identified by the HTTP communication monitor.

3. A system according to claim 1 wherein the system also comprises a cookie generator and wherein the controller also stores an alternative value in the user device's cookie store.

4. A system according to claim 3 wherein the alternative value comprises a fake cookie value, generated by the cookie generator, thereby to store at least one real value outside the cookie store corresponding to at least one fake value in the cookie store.

5. A system according to claim 1 wherein the controller deletes the entire incoming cookie value from the user device's browser's cookie store.

6. A system according to claim 1 wherein the location at which the incoming cookie value is stored, is on the user's device outside of the browser's cookie store.

7. A method for enhancing a user's browsing security, the method comprising:
providing solution code on a user's device (e.g., in the device's browser program);
each time a user browses to a service or webapp made available to users by a webapp server, using the solution code for:
removing at least one real cookie which was sent to the user's browser by the webapp server and has been stored by user U's browser in a cookie store in the user's device;
storing the real cookie in storage accessible to the solution code but outside the cookie store;
and subsequently, on at least one occasion when the browser on the user's device sends a request which needs to include said real cookie (e.g., a request which needs to include a session cookie), toward said service/webapp, accessing the real cookie from said storage outside the cookie store, modifying the request by adding the real cookie as accessed, and sending the request as modified on to the webapp server.

8. A method according to claim 7 wherein a fake cookie is stored in the user device's browser program's cookie store, and wherein subsequently, the request is modified by replacing a cookie value within the request, which, having been retrieved by the browser program from the cookie store, is fake, with the real cookie value.

9. A method according to claim 7 wherein said removing comprises:
replacing at least one real cookie which was sent to the user's browser by the webapp server and has been stored by user U's browser in a cookie store in the user's device, with a fake cookic value;
removing said cookie from the cookie store; and/or
storing a blank value in said cookie's value, instead of the real value that was removed.

10. A method according to claim 9 wherein the method includes removing the fake cookie each time the session is revoked by the user or the service itself.

11. A system according to claim 1 wherein the system is implemented in solution code and wherein the real value is stored in a secured location such as the solution code's sandboxed memory.

12. A system according to claim 1 wherein the real value is stored encrypted on the user device's file system.

13. A system according to claim 1 wherein the real values are stored in plain text, i.e., un-encrypted on process memory managed by the operating system of the user's device.

14. A system according to claim 1 wherein at least one incoming cookie value, which needs to be stored on the user's device for persistence, is stored encrypted on the device's file system.

15. A system according to claim 4 wherein the controller adds the at least one real value outside the cookie store by replacing the outgoing cookie value, which, having been retrieved by the browser from the cookie store, is fake, with at least one real value outside the cookie store corresponding to the fake outgoing cookie value.

16. A system according to claim 3 wherein the alternative value comprises a null string comprising zero characters.

17. A system according to claim 1 wherein the location at which the incoming cookie value is stored, is in device memory.

18. A computer program product, comprising a non-transitory tangible computer readable medium having computer readable program code embodied therein, said computer readable program code adapted to be executed to implement a method for enhancing a user's browsing security, the method comprising:
each time a user browses to a service or webapp made available to users by a webapp server, using the solution code on a user's device for:
removing at least one real cookie which was sent to the user's browser by the webapp server and has been stored by user U's browser in a cookie store in the user's device;
storing the real cookie in storage accessible to the solution code, but outside the cookie store;
and subsequently, on at least one occasion when the browser on the user's device sends a request which needs to include said real cookie (e.g., a request which needs to include a session cookie), toward said service/webapp, accessing the real cookie from said storage outside the cookie store, modifying the request by adding the real cookie as accessed, and sending the request as modified on to the webapp server
